(19) United States
(12) Patent Application Publication
(10) Pub. No.: US 2002/0018917 A1
(43) Pub. Date: Feb. 14, 2002

(54) Perpendicular magnetic recording medium

(76) Inventors: Yasushi Sakai, Nagano (JP); Kazuo Enomoto, Nagano (JP); Sadayuki Watanabe, Nagano (JP)

Correspondence Address: MORRISON LAW FIRM, 145 North Fifth Avenue, Mt. Vernon, NY, 10550, US

(21) Appl. No.: 09/902,534

(22) Filed: Jul. 10, 2001

(30) Foreign Application Priority Data
Jul. 11, 2000 (JP) 2000-210308

(51) Int. Cl. G11B 5/66

(52) U.S. Cl. 428/694 TM

(57) ABSTRACT

A perpendicular magnetic recording medium includes a multi-layer magnetic recording layer supported on a non-magnetic substrate. One of the magnetic recording layers includes a magnetic film of a rare earth-transitional metal alloy amorphous material. An embodiment of the rare earth-transitional metal alloy amorphous material additionally includes Cr to improve corrosion resistance. Another of the magnetic recording layers includes a magnetic layer of a CoCr alloy crystalline film. In combination, the multilayer magnetic recording layer provides increased recording density, lower noise, and increased durability.

### BACKGROUND OF THE INVENTION

The present invention relates to a perpendicular magnetic recording medium that is mounted on various magnetic recording devices.

In recent years, as a technique for achieving high densities in magnetic recording media, there has been increasing interest in perpendicular magnetic recording systems instead of the longitudinal magnetic recording system of the related art.

A perpendicular magnetic recording medium is constructed from a magnetic recording layer of a hard magnetic material and a back layer of a soft magnetic material. The back layer is responsible for concentrating the magnetic flux that is generated by a magnetic head, which is used in recording to the recording layer.

In general, a Co alloy crystalline film, which is also used for longitudinal recording media, is used as the material for the magnetic recording layer in the perpendicular magnetic medium. In response to demand for increasingly high densities in magnetic recording media; refining Co crystal grains, reducing particle size distribution, and controlling interactions between grains have been studied as ways to increase recording density. There has also been a search for a composition having a greater perpendicular anisotropy.

In addition, as a thin film having a large perpendicular anisotropy, rare earth-transitional metal alloy amorphous films have also been seen as promising as material for perpendicular magnetic recording medium.

Currently, Co alloy crystalline magnetic recording materials are mainly used. A magnetic recording layer formed from Co alloy crystalline magnetic recording material has a column-like structure constructed by the growth of crystal grains in the film thickness direction. This structure is one of the major reasons why noise is generated during recording and play back.

With the increasing recording densities in the future, the effect of this crystal grain boundary on the recording signal will become ever greater. With respect to this problem, there have been attempts to reduce this effect by having a finer crystal grain size, unfortunately when the crystal grain size becomes too small, the thermal stability of the recorded signal dramatically deteriorates. In some situations, the recorded signal could disappear. The problem of thermal fluctuation can surface rapidly causing additional concerns.

When a rare earth-transitional metal alloy amorphous film is used, because it is amorphous, there are no crystal grain boundaries. The above problem does not arise. However, since no grain boundaries exist, there is no nucleus for holding the written signal to its location. As a result, the signal can shift or disappear. This phenomenon is especially common when recording at high frequency. These characteristics are not desirable for perpendicular recording medium material that has the objective of having a high recording density.

### OBJECTS AND SUMMARY OF THE INVENTION

It is an object of the present invention to provide a perpendicular magnetic recording medium that avoids the above concerns.

Through research, the present inventors discovered that by forming a magnetic recording layer by layering a CoCr alloy crystalline film and a rare earth-transitional metal alloy amorphous film, a perpendicular magnetic recording medium that has low noise and can support high density recording can be created.

Based on this discovery, the perpendicular magnetic recording medium of the one embodiment of the present invention has a multi-layer construction for the magnetic recording layer, and of these, at least one layer is a magnetic film of a rare earth-transitional metal alloy amorphous material. For the structure of this multi-layer magnetic recording layer, the following three are considered.

In a first embodiment, a multi-layer magnetic recording layer is constructed from a magnetic layer of two layers. The first layer is a magnetic layer of a CoCr alloy crystalline film. The second layer is a magnetic layer of a rare earth-transitional metal alloy amorphous film.

In a second embodiment, the magnetic recording layer is constructed from a magnetic layer of two layers. The first layer is a magnetic layer of a rare earth-transitional metal alloy amorphous film. The second layer is a magnetic layer of a CoCr alloy crystalline film.

In a third embodiment, the magnetic recording layer is constructed from a magnetic layer of at least two or more layers. At least one of the layers is a magnetic layer of a rare earth-transitional metal alloy amorphous film.

It is to be understood, that according to the embodiments of the present invention, it is preferable but not essential to have the rare earth-transitional metal alloy amorphous film contain at least one or more elements selected from the group consisting of Pr, Nd, Gd, Tb, Dy, and Ho.

In addition, the rare earth-transitional metal alloy amorphous film preferably but not essentially contains 10 atm % or greater and 35 atm % or less of at least one or more rare earth elements. In addition, the remainder contains at least one transitional metal selected from the group consisting of Ni, Fe, and Co.

Further, it is preferable but not essential that this rare earth-transitional metal alloy amorphous film contain 5 atm % or greater and 25 atm % or less of Cr.

Briefly, the present invention pertains to a perpendicular magnetic recording medium including a multi-layer magnetic recording layer. One of the magnetic recording layers includes a magnetic film of a rare earth-transitional metal alloy amorphous material. The rare earth-transitional metal alloy amorphous material may additionally include Cr to improve corrosion resistance. Another of the magnetic recording layers includes a magnetic layer of a CoCr alloy crystalline film. In combination, the multilayer magnetic recording layer provides increased recording density, lower noise, and increased durability.

According to an embodiment of the present invention there is provided a perpendicular magnetic recording medium, comprising: anon-magnetic substrate, a soft magnetic back layer on the non-magnetic substrate, an intercoat layer on the soft magnetic back layer, a multi-layer magnetic recording layer on the intercoat layer, a protective layer on the multi-layer magnetic recording layer, a liquid lubricant layer on the protective layer, and the multi-layer magnetic recording layer including at least a first and a second magnetic layer effective to reduce noise and increase an information density capability of the perpendicular magnetic recording medium.

According to an embodiment of the present invention there is provided a perpendicular magnetic recording medium, wherein: the first magnetic layer is at least one of a magnetic layer of a CoCr alloy crystalline film and a magnetic layer of a rare earth-transitional metal alloy amorphous film, and the second magnetic layer is the other of the magnetic layer of the CoCr-alloy crystalline film and the magnetic layer of the rare earth-transitional metal alloy amorphous film.

According to an embodiment of the present invention there is provided a perpendicular magnetic recording medium, wherein: the rare earth-transitional metal alloy amorphous film contains at least one element selected from a group consisting of Pr, Nd, Gd, Tb, Dy, and Ho.

According to an embodiment of the present invention there is provided a perpendicular magnetic recording medium, wherein: the rare earth-transitional metal alloy amorphous film contains between 10 percent and 35 percent of the at least one element, and a remainder portion of the rare earth-transitional metal alloy amorphous film contains at least one transitional metal element selected from a group consisting of Ni, Fe, and Co.

According to an embodiment of the present invention there is provided a perpendicular magnetic recording medium, wherein: the rare earth-transitional metal alloy amorphous film contains between 5 percent and 25 percent of Cr effective to improve a corrosion resistance of the perpendicular magnetic recording medium.

According to an embodiment of the present invention there is provided a perpendicular magnetic recording medium, comprising: a non-magnetic substrate, a soft magnetic back layer on the non-magnetic substrate, an intercoat layer on the soft magnetic back layer, a multi-layer magnetic recording layer on the intercoat layer, a protective layer on the multi-layer magnetic recording layer, a liquid lubricant layer on the protective layer, the multi-layer magnetic recording layer including at least a first and a second magnetic layer effective to reduce noise and increase an information density capability of the perpendicular magnetic recording medium, and at least one of the first and the second magnetic layers being a magnetic layer of a rare earth-transitional metal alloy amorphous film.

According to an embodiment of the present invention there is provided a perpendicular magnetic recording medium, wherein: the rare earth-transitional metal alloy amorphous film contains at least one element selected from a group consisting of Pr, Nd, Gd, Tb, Dy, and Ho.

According to an embodiment of the present invention there is provided a perpendicular magnetic recording medium, wherein: the rare earth-transitional metal alloy amorphous film contains between 10 percent and 35 percent of the at least one element, and a remainder portion of the rare earth-transitional metal alloy amorphous film containing at least one transitional metal element selected from a group consisting of Ni, Fe, and Co.

According to an embodiment of the present invention there is provided a perpendicular magnetic recording medium, wherein: the rare earth-transitional metal alloy amorphous film containing between 5 percent and 25 percent of Cr effective to improve a corrosion resistance of the perpendicular magnetic recording medium.

According to an embodiment of the present invention there is provided a perpendicular magnetic recording medium, comprising: a non-magnetic substrate, a soft magnetic back layer on the non-magnetic substrate, an intercoat layer on the soft magnetic back layer, a multi-layer magnetic recording layer on the intercoat layer, a protective layer on the multi-layer magnetic recording layer, a liquid lubricant layer on the protective film layer, the multi-layer magnetic recording layer including at least a first and a second magnetic layer effective to reduce noise and increase an information density capability of the perpendicular magnetic recording medium, the first magnetic layer is at least one of a magnetic layer of a CoCr alloy crystalline film and a magnetic layer of a rare earth-transitional metal alloy amorphous film, the second magnetic layer is the other of the a magnetic layer of the CoCr alloy crystalline film and the magnetic layer of the rare earth-transitional metal alloy amorphous film, and the rare earth-transitional metal alloy amorphous film containing at least one element selected from a group consisting of Pr, Nd, Gd, Tb, Dy, and Ho.

According to an embodiment of the present invention there is provided a perpendicular magnetic recording medium, comprising: a non-magnetic substrate, a soft magnetic back layer on the non-magnetic substrate, an intercoat layer on the soft magnetic back layer, a multi-layer magnetic recording layer on the intercoat layer, a protective layer on the multi-layer magnetic recording layer, a liquid lubricant layer on the protective layer, the multi-layer magnetic recording layer including at least a first and a second magnetic layer effective to reduce noise and increase an information density capability of the perpendicular magnetic recording medium, at least one of the first and the second magnetic layers being a magnetic layer of a rare earth-transitional metal alloy amorphous film, the rare earth-transitional metal alloy amorphous film containing at least one element selected from a group consisting of Pr, Nd, Gd, Tb, Dy, and Ho, the rare earth-transitional metal alloy amorphous film containing between 10 percent and 35 percent of the at least one element, and a remainder portion of the rare earth-transitional metal alloy amorphous film containing at least one transitional metal element selected from a group consisting of Ni, Fe, and Co.

The above, and other objects, features, and advantages of the present invention will become apparent from the following description read in conjunction with the accompanying drawings, in which like reference numerals designate the same elements.

### BRIEF DESCRIPTION OF THE FIGURES

FIG. 1 is a cross-section model diagram showing a layered structure of a perpendicular magnetic recording medium.

FIG. 2 is a graph showing how the coercivity of the magnetic recording medium created in an embodiment depends on Tb composition.

FIG. 3 is a graph showing the hysteresis loop for a magnetic recording medium created in an embodiment of the present invention.

FIG. 4 is a graph showing the results of measuring the changes in the magnetic properties for magnetic recording media created with different sputtering rates.

FIG. 5 is a graph explaining an embodiment of the present invention and showing how the SNR of the CoCrPtTa film, TbCoCr film, and the layered film of the magnetic recording media created in the embodiments depends on the recording density.

FIG. 6 is a graph showing the results of measuring the Cr concentration dependence of the saturation magnetization and the increase in number of errors with respect to the magnetic recording media created in an embodiment.

### DESCRIPTION OF THE PREFERRED EMBODIMENTS

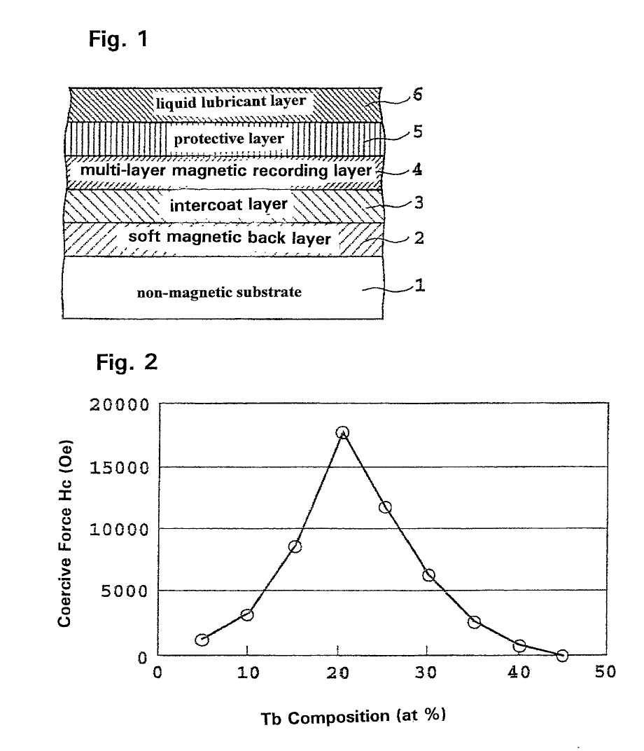

Referring now to FIG. 1, a cross-section of a perpendicular magnetic recording medium includes a soft magnetic back layer 2, an intercoat layer 3, a multi-layer magnetic recording layer 4, and a protective layer 5 each formed in order on a surface of a non-magnetic substrate 1. A liquid lubricant layer 6 is formed on top of the perpendicular magnetic recording medium, as will be described.

It is to be understood, that for purpose of understanding the below description the first layer of multi-layer magnetic recording layer 4 is adjacent intercoat layer 3.

For non-magnetic substrate 1, a conventional substrate used for magnetic recording media is used. Either an Al alloy with NiP plating or strengthened glass or crystalline glass can be used. To conduct magnetic domain control of soft magnetic back layer 2, between non-magnetic substrate 1 and soft back layer 2, either an anti-ferromagnetic layer of an Mn alloy can be used, or a hard magnetic layer in which the magnetization is oriented in the radial direction of nonmagnetic substrate 1 can be used.

Intercoat layer 3 controls the crystal orientation and crystal grain size of multi-layer magnetic recording layer 4. Examples of materials that may be used for intercoat layer 3 include TiCr alloy and CoCr alloy. For protective layer 5, a thin film mainly of carbon may be used. Additionally, liquid lubricant layer 6 may be a perfluoropolyether lubricant.

In a first embodiment for multi-layer magnetic recording layer 4 is constructed from a two layer magnetic layer. The first layer is a magnetic layer of a CoCr alloy crystalline film, and the second layer is a magnetic layer of a rare earth-transitional metal alloy amorphous film.

In addition, in the second embodiment for this multi-layer magnetic recording layer 4, in reverse of the first embodiment, the first layer of the two layered magnetic layer is a magnetic layer of a rare earth-transitional metal alloy amorphous film, and the second layer is a magnetic layer of a CoCr alloy crystalline film.

Furthermore, for the third embodiment of multi-layer magnetic recording layer 4, having a construction with a magnetic layer of two or more layers is effective in noise reduction. Even in this situation, at least one layer of the magnetic layer with two or more layers is a magnetic layer of a rare earth-transitional metal alloy amorphous film.

In the perpendicular magnetic recording medium of the present invention, examples of materials that can be used as CoCr alloy crystalline film include but are not limited to alloys of CoCr, CoCrPt, CoCrPtTa, CoCrPtB.

In addition, examples of materials that can be used for rare earth-transitional metal alloy amorphous films include but are not limited to alloys of TbCo, TbFeCo, TbCoCr, TbFeCoCr. In this situation, a composition in which the sum of the rare earth elements that are added is 10 atm % or greater and 35 atm % or less is particularly effective for creating a good perpendicular magnetic film. For the transitional metal material of the remainder, it should contain at least one or more elements selected from a group consisting of Ni, Fe, and Co.

In general it is known that rare earth-transitional metal alloy amorphous films do not have good corrosion resistance. By adding Cr at 5 atm % or greater and 25 atm % or less, this corrosion resistance can be improved.

The embodiments of the present invention are described below. It should be understood, however that the following embodiments are only representative examples that are suitable for describing the present invention, and the present invention is not limited to these embodiments.

For the non-magnetic substrate, a chemically strengthened glass substrate (for example N-10 glass substrate manufactured by Hoya Co.) having a smooth surface was used. After washing, this was brought into a sputter device, and a CoZrNb amorphous soft magnetic backing layer was formed at a thickness of 200 nm. Next, using a lamp heater, heating was conducted to a substrate surface temperature of 250 degrees C. Afterwards, a TiCr undercoat film of 10 nm thickness, a CoCrPtTa magnetic layer of 10 nm thickness, and a TbCoCr magnetic layer of 20 nm thickness were formed.

Finally, after a protective film of carbon of a 5 nm thickness was formed, this was removed from the vacuum device. These film formations were all conducted under an Ar gas atmosphere of 5 m Torr and by a DC magnetron sputtering method. Afterwards, a liquid lubricant material layer of perfluoropolyether was formed at a 2 nm thickness by a dip method, and the perpendicular magnetic recording medium was completed.

The magnetic properties of the manufactured perpendicular magnetic recording medium were calculated by measuring the hysteresis loop by an oscillating sample-type magnetometer. In addition, the electromagnetic conversion property of the resulting perpendicular magnetic recording medium was measured by a MR head using a spin stand tester. The anti-corrosion test of this perpendicular magnetic recording medium was evaluated by the increase in number of errors before and after leaving this perpendicular magnetic recording medium for 72 hours in an environment of 80 degrees C/80 %Rh.

Additionally referring now to FIG. 2, the magnetic recording layer is only one layer of a TbCoCr layer. Shown are changes in the coercivity of the perpendicular magnetic recording medium when the Tb composition was changed. With a Th composition in the range of 10 atm % or greater and 35 atm % or less, a high coercivity that is usable as a perpendicular magnetic recording medium can be achieved. Similar results can be obtained by using Pr, Nd, Gd, Dy, Ho in place of Tb. In addition, even where two or more of these elements are combined, the total concentration of the rare earth element was optimal in the range of 10 atm % or greater and 35 atm % or less.

Next, as one example, the multi-layer magnetic recording layer was made to have a two layer construction. For the first layer, a CoCrTaPt film with a 10 nm thickness and for the second layer, a TbCoCr film with a film thickness of 20 nm was layered, and a perpendicular magnetic recording medium was manufactured.

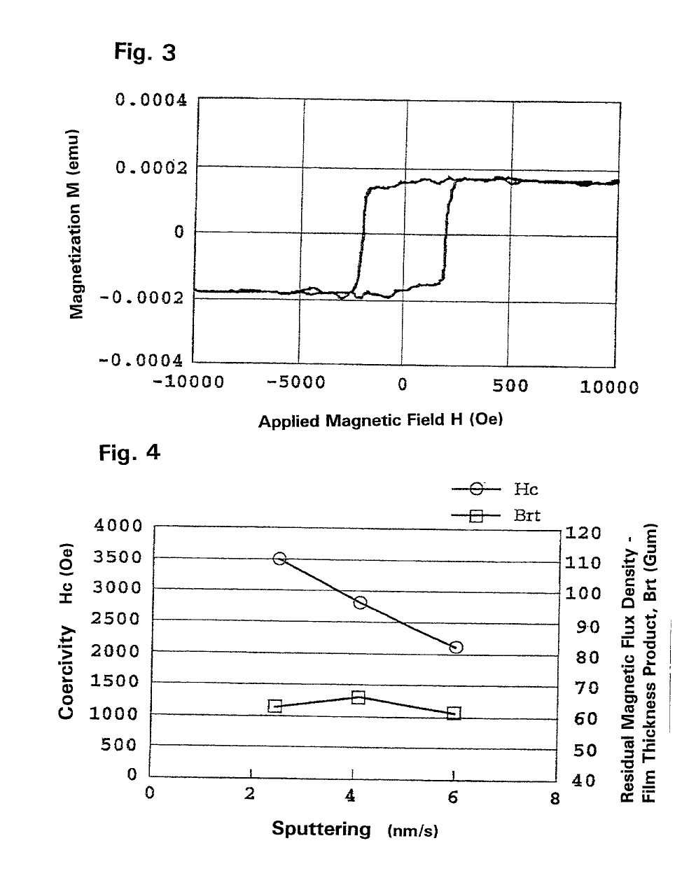

Additionally referring now to FIG. 3, the hysteresis loop of the resulting perpendicular magnetic recording medium is shown. It is noted that even though magnetic layers of different magnetic properties were layered, the magnetization of the magnetic film of the first layer and the magnetization of the magnetic film of the second layer were magnetically joined. A hysteresis loop that is seen with a single layer medium was achieved.

However, if the ratio of the film thicknesses differs greatly, the magnetization of the first layer and the magnetization of the second layer no longer magnetically join. As a result, the magnetization curve becomes a shape in which the hysteresis loop of the magnetic film of the first layer is overlaid on the second layer. A perpendicular magnetic recording medium with this kind of layer construction cannot achieve good results in terms of recording characteristics.

Additional referring now to FIG. 4, the sputtering conditions of the CoCrTaPt film of the first layer were fixed, and the sputtering rate for the TbCoCr film of the second layer was changed. FIG. 4 shows the changes in the magnetic properties of the perpendicular magnetic recording medium. It is noted, that while residual magnetic flux density-film thickness product is maintained at a constant, the coercivity alone can be made larger. Furthermore, by changing the sputtering conditions, such as sputtering gas pressure and gas flow rate, the coercivity can also be changed. In sum, the residual magnetic flux density-film thickness product can be easily adjusted by changing the film thickness of the magnetic recording layer.

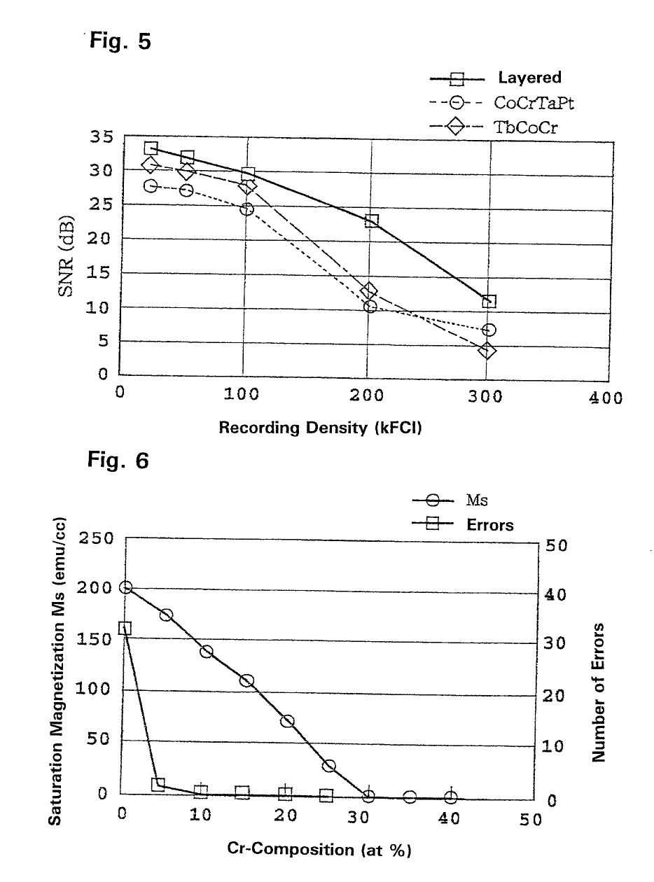

Additionally referring now to FIG. 5, the recording density dependency of the SNR (the signal to noise ratio of the recording characteristics) of the perpendicular magnetic recording medium of the present invention is shown. For comparison, the results for a magnetic recording medium using a CoCrPtTa film alone for the magnetic recording layer and a magnetic recording medium using only a TbCoCr film are also shown. With the TbCoCr film, in the recording density range of 200 KFCI or greater, the signal could not be written, and the SNR rapidly decreased. However, by having a layered magnetic recording layer, the SNR could be maintained at a good value even at high recording density ranges.

Additionally referring now to FIG. 6, Cr was added to the TbCo that was the material for the multi-layer magnetic recording layer. FIG. 6 shows the saturation magnetization Ms and the increase in number of errors with respect to the Cr composition. When Cr was added, Ms decreased in a monotone manner.

When 30 atm % or greater was added, the saturation magnetization of the TbCoCr film became 0. Therefore, for the Cr concentration, it must be 25 atm % or less. Furthermore, looking at the increase in number of errors, when Cr was not added, there was an increased number of errors, but by adding 5 atm % or greater, the increase in the number of errors could be prevented. Therefore, when Cr is added for the purposes of improving the anti-corrosion properties of the rare earth-transitional metal alloy amorphous film, it is desirable to add 5 atm % or greater and 25 atm % or less.

As described above, with the present invention, the magnetic recording layer of a perpendicular magnetic recording medium is constructed by layering two or more magnetic layers. At least one of these layers is a magnetic film of a rare earth-transitional metal alloy amorphous film. With the present invention, a perpendicular magnetic recording medium exhibiting good SNR qualities even at high recording densities can be achieved.

Furthermore, the layered medium of the multi-layer magnetic recording layer constructing the perpendicular magnetic recording medium of the present invention can be easily produced using existing manufacturing devices.

Therefore, the perpendicular magnetic recording medium of the present invention is well-suited to be mass produced as a large capacity magnetic recording medium.

It is to be understood that while the above describes the preferred embodiments, under the full scope of the present invention, liquid lubricant layer 6 may be either a liquid lubricant layer or other non-liquid lubricant layer, such as a gel, a plastic, a metal, or other substance sufficient to accommodate the requirements of layer 6 and allow the invention to function, although not necessarily at peak effectiveness.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A perpendicular magnetic recording medium, comprising:
a non-magnetic substrate;
a soft magnetic back layer on said non-magnetic substrate;
an intercoat layer on said soft magnetic back layer;
a multi-layer magnetic recording layer on said intercoat layer;
a protective layer on said multi-layer magnetic recording layer;
a liquid lubricant layer on said protective layer; and
said multi-layer magnetic recording layer including at least a first and a second magnetic layer effective to reduce noise and increase an information density capability of said perpendicular magnetic recording medium.

2. A perpendicular magnetic recording medium, according to claim 1, wherein:
said first magnetic layer is at least one of a magnetic layer of a CoCr alloy crystalline film and a magnetic layer of a rare earth-transitional metal alloy amorphous film; and
said second magnetic layer is said other of said magnetic layer of said CoCr-alloy crystalline film and said magnetic layer of said rare earth-transitional metal alloy amorphous film.

3. A perpendicular magnetic recording medium, according to claim 2, wherein:
said rare earth-transitional metal alloy amorphous film contains at least one element selected from a group consisting of Pr, Nd, Gd, Tb, Dy, and Ho.

4. A perpendicular magnetic recording medium, according to claim 3, wherein:
said rare earth-transitional metal alloy amorphous film contains between 10 percent and 35 percent of said at least one element; and
a remainder portion of said rare earth-transitional metal alloy amorphous film containing at least one transitional metal element selected from a group consisting of Ni, Fe, and Co.

5. A perpendicular magnetic recording medium, according to claim 4, wherein:
said rare earth-transitional metal alloy amorphous film contains between 5 percent and 25 percent of Cr effective to improve a corrosion resistance of said perpendicular magnetic recording medium.

6. A perpendicular magnetic recording medium, comprising:
a non-magnetic substrate;
at least a soft magnetic back layer on said non-magnetic substrate;
an intercoat layer on said soft magnetic back layer;
a multi-layer magnetic recording layer on said intercoat layer;
a protective layer on said multi-layer magnetic recording layer;
a lubricant layer on said protective layer;
said multi-layer magnetic recording layer including a plurality of magnetic layers effective to reduce noise and increase an information density capability of said perpendicular magnetic recording medium; and
at least one of said plurality of magnetic layers being a magnetic layer of a rare earth-transitional metal alloy amorphous film.

7. A perpendicular magnetic recording medium, according to claim 6, wherein:
said rare earth-transitional metal alloy amorphous film contains at least one element selected from a group consisting of Pr, Nd, Gd, Tb, Dy, and Ho.

8. A perpendicular magnetic recording medium, according to claim 7, wherein:
said rare earth-transitional metal alloy amorphous film contains between 10 percent and 35 percent of said at least one element; and
a remainder portion of said rare earth-transitional metal alloy amorphous film contains at least one transitional metal element selected from a group consisting of Ni, Fe, and Co.

9. A perpendicular magnetic recording medium, according to claim 8, wherein:
said rare earth-transitional metal alloy amorphous film contains between 5 percent and 25 percent of Cr effective to improve a corrosion resistance of said perpendicular magnetic recording medium.

10. A perpendicular magnetic recording medium, comprising:
a non-magnetic substrate;
at least a soft magnetic back layer on said non-magnetic substrate;
an intercoat layer on said soft magnetic back layer;
a multi-layer magnetic recording layer on said intercoat layer;
a protective layer on said multi-layer magnetic recording layer;
a liquid lubricant layer on said protective layer;
said multi-layer magnetic recording layer including at least a first and a second magnetic layer effective to reduce noise and increase an information density capability of said perpendicular magnetic recording medium;
said first magnetic layer is at least one of a magnetic layer of a CoCr alloy crystalline film and a magnetic layer of a rare earth-transitional metal alloy amorphous film;
said second magnetic layer is said other of said a magnetic layer of said CoCr alloy crystalline film and said magnetic layer of said rare earth-transitional metal alloy amorphous film; and
said rare earth-transitional metal alloy amorphous film containing at least one element selected from a group consisting of Pr, Nd, Gd, Tb, Dy, and Ho.

11. A perpendicular magnetic recording medium, comprising:
a non-magnetic substrate;
at least a soft magnetic back layer on said non-magnetic substrate;
an intercoat layer on said soft magnetic back layer;
a multi-layer magnetic recording layer on said intercoat layer;
a protective layer on said multi-layer magnetic recording layer;
a lubricant layer on said protective layer;
said multi-layer magnetic recording layer including a plurality of magnetic layers effective to reduce noise and increase an information density capability of said perpendicular magnetic recording medium;
at least one of said plurality of magnetic layers being a magnetic layer of a rare earth-transitional metal alloy amorphous film;
said rare earth-transitional metal alloy amorphous film containing at least one element selected from a group consisting of Pr, Nd, Gd, Tb, Dy, and Ho;
said rare earth-transitional metal alloy amorphous film containing between 10 percent and 35 percent of said at least one element; and
a remainder portion of said rare earth-transitional metal alloy amorphous film containing at least one transitional metal element selected from a group consisting of Ni, Fe, and Co.

12. A perpendicular magnetic recording medium, comprising:
a non-magnetic substrate;
a soft magnetic back layer on said non-magnetic substrate;
an intercoat layer on said soft magnetic back layer;
a multi-layer magnetic recording layer on said intercoat layer;
a protective layer on said multi-layer magnetic recording layer;
a lubricant layer on said protective layer; and
said multi-layer magnetic recording layer including at least a first and a second magnetic layer effective to reduce noise and increase an information density capability of said perpendicular magnetic recording medium.
